(19) United States
(12) Patent Application Publication
(10) Pub. No.: US 2017/0334298 A1
(43) Pub. Date: Nov. 23, 2017

(54) Method for Charging an Energy Store in a Motor Vehicle with Readiness Signalling, and Charging System

(71) Applicant: Daimler AG, Stuttgart (DE)

(72) Inventor: Timo Baumer, Stuttgart (DE)

(73) Assignee: Daimler AG, Stuttgart (DE)

(21) Appl. No.: 15/533,949

(22) PCT Filed: Nov. 3, 2015
(86) PCT No.: PCT/EP2015/002197

§ 371 Date: Jun. 7, 2017

(30) Foreign Application Priority Data
Dec. 13, 2014 (DE) 10 2014 018 674.1

(51) Int. Cl. B60L 11/18; G08B 5/36; G09F 13/00

(52) U.S. Cl. CPC B60L 11/182; G08B 5/36; G09F 13/00

(57) ABSTRACT

A method for charging an energy store in a motor vehicle by inductive energy transmission from an energy transmission unit to the motor vehicle is disclosed. The energy transmission unit can be anchored in a stationary manner on an accessible surface and is part of an inductive charging station. A communication channel is constructed between the inductive charging station and the motor vehicle for the purpose of preparing for and/or carrying out charging of the energy store. The inductive charging station provides a light signal which is to be perceived by a driver of the motor vehicle and which is not transmitted via the communication channel for signaling the readiness for charging the energy store. A charging system is also disclosed.

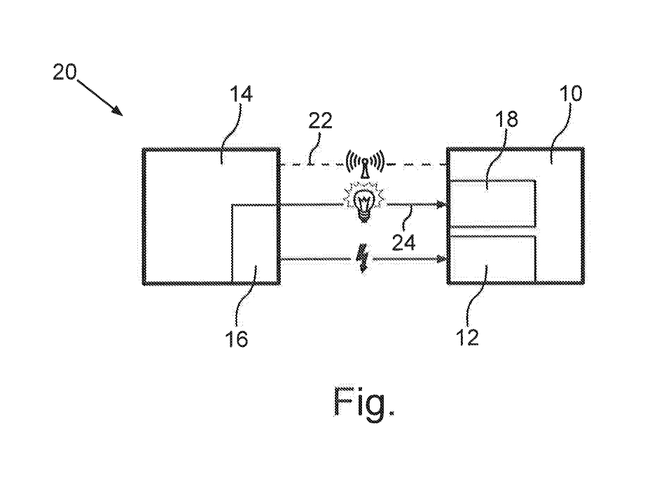

### BACKGROUND AND SUMMARY OF THE INVENTION

The invention relates to a method for charging an energy store in a motor vehicle by means of inductive energy transmission from an energy transmission unit, which can be anchored in a stationary manner on an accessible surface and which is part of an inductive charging station, to the motor vehicle, wherein a communication channel is constructed between the inductive charging station and the motor vehicle for the purpose of preparing for and/or carrying out charging of the energy store. Furthermore, the invention relates to a charging system with a motor vehicle, which has an energy store, an inductive charging station for charging the energy store in the motor vehicle by means of inductive energy transmission, with an energy transmission unit, which can be anchored in a stationary manner on an accessible surface and which is part of an inductive charging station, and with a communication channel between the inductive charging station and the motor vehicle for the purpose of preparing for and/or carrying out charging of the energy store.

An electric vehicle or hybrid vehicle, the battery of which is to be charged from an external power source, requires an electrical connection to a supplying network. In the simplest case this is a cable connection, by means of which the external power source is connected to the motor vehicle. In particular, requirements for protection against contact foreign bodies (contamination) should be taken into consideration. As an alternative to the wired power transmission, wireless power transmission, also referred to as contactless power transmission, is available. In this case, it is necessary to position the vehicle as precisely as possible with respect to a stationary charging station in order to achieve the best possible efficiency for the power transmission. For a high degree of flexibility it may be advantageous in this case if charging stations are provided at public parking spaces.

In this connection JP 2012-135135 discloses a vehicle charging system, which comprises a communication part outside a vehicle for transmission of information to the parked vehicle to draw attention to a charging device, a communication part in the vehicle for receiving the information as well as a display part and an audio output part in the vehicle which informs a driver based on the information item about the presence of the charging device.

An object of the present invention is to provide a method and a charging system which enables a particularly simple way of making the contact between a charging device and a driver of a motor vehicle.

The invention relates to a method for charging an energy store in a motor vehicle by means of inductive energy transmission from an energy transmission unit, which can be anchored in a stationary manner on an accessible surface and which is part of an inductive charging station, to the motor vehicle, wherein a communication channel is constructed between the inductive charging station and the motor vehicle for the purpose of preparing for and/or carrying out charging of the energy store. The method according to the invention is modified in such a way that the inductive charging station provides a light signal, which is to be perceived by a driver of the motor vehicle and which is not transmitted via the communication channel, for signaling the readiness for charging the energy store of the motor vehicle.

Accordingly a charging system with a motor vehicle, which has an energy store, an inductive charging station for charging the energy store in the motor vehicle by means of inductive energy transmission, with an energy transmission unit which can be anchored in a stationary manner on an accessible surface and which is part of an inductive charging station, and also with a communication channel between the inductive charging station and the motor vehicle for the purpose of preparing for and/or carrying out charging of the energy store, modified in such a way that the inductive charging station is designed to provide a light signal which is to be perceived by a driver of the motor vehicle and which is not transmitted via the communication channel, for signaling the readiness for charging of the energy store of the motor vehicle.

This results in a particularly simple possibility for identifying the charging station, and simultaneously the light signal offers an optical conducting function to the charging station. Furthermore, the charging station can signal the readiness for charging so that, for example, a defective charging station can also be identified. Thus, even if the power supply from the supplying network is not available (power failure), the driver of the motor vehicle can refrain from activating the charging station with his vehicle based on the lack of a readiness signal. Particularly advantageously the readiness signal can also be used in order to indicate a compatibility of the charging station with the motor vehicle.

The provision of the light signal can preferably take place via the energy transmission unit before a final charging position of the motor vehicle is reached. In particular, the provision of the light signal can already begin before the positioning operation is initiated. As a result, it is already possible to signal to the driver of the motor vehicle, from a considerable distance, whether a charging operation is actually possible.

In a preferred embodiment, the light signal is transmitted by the energy transmission unit. As a result, the motor vehicle driver's attention is drawn directly to the energy transmission unit, by means of which the motor vehicle must be positioned. However, it may also be provided that the parking place which is provided for parking of the motor vehicle during the charging of the energy store can be illuminated as a whole or within a frame. For example, it may also be provided that as a function of the vehicle dimensions only a specific area of the parking place is highlighted by the light signal.

In a preferred embodiment, the provision of the light signal can take place after the communication channel is set up, and in particular the provision of the light signal can take place immediately thereafter. This produces the advantage that immediately after the connection between the charging station and the motor vehicle is set up the motor vehicle driver is informed via the communication channel about the presence and the location of the charging station, in particular the energy transmission unit.

The communication channel can preferably be implemented by a radio connection, for example WLAN, Bluetooth and the like. As a result, infrastructures which already exist can be used.

In a preferred embodiment, the light signal is provided with a time progression which is pulsating and/or is constant at least in some sections. As a result, the motor vehicle driver's attention is directed particularly effectively to the light signal.

Numbers, characters and/or graphical symbols in any combination can preferably be made visible and/or highlighted by means of the light signal. In this way, further information can be provided to the motor vehicle driver.

The advantages and features as well as embodiments described for the method according to the invention apply equally to the charging system according to the invention and vice versa. Consequently, corresponding device features can be provided for method features and vice versa.

Further advantages, features and details of the invention can be seen from the following description of a preferred exemplary embodiment and with reference to the drawing. The features and combinations of features stated above in the description and the features and combinations of features stated below in the description of the drawing and/or shown in the single drawing can be used not only in the specified combination in each case, but also in other combinations or in isolation without departing from the scope of the invention.

### BRIEF DESCRIPTION OF THE DRAWING

The FIGURE shows a schematic representation of a charging system according to the invention.

### DETAILED DESCRIPTION OF THE DRAWING

The invention relates to a motor vehicle 10 with an energy store 12, preferably an electrical energy storage device which is, for example, made up of lithium ion cells. For charging of the energy store 12 an inductive charging station 14 is used, which has an energy transmission unit 16 arranged, for example, on the floor of a parking place equipped with an inductive charging station 14. During charging of the energy store 12, a transmission of energy between the energy transmission unit 16 and the energy store 12 takes place which is illustrated by an arrow in the single drawing. In this case, an energy receiving unit (not shown in the single drawing) belonging to the motor vehicle 10 serves as a counterpart to the energy transmission unit 16.

A motor vehicle driver 18, or a region of the motor vehicle 10 from which visual contact is usually established with the surroundings of the motor vehicle 10, is likewise illustrated. Thus, the motor vehicle driver 18 is only representative of a region of the motor vehicle 10.

For preparing for and/or carrying out charging of the energy store 12 a communication channel 22 is set up between the inductive charging station 14 and the motor vehicle 10. This communication channel 22 can preferably be based on a wireless connection, in particular WLAN, Bluetooth or the like. After the communication channel 22 is set up, the inductive charging station 14 provides a light signal 24 which serves for signaling the readiness for charging of the energy store 12 of the motor vehicle 10.

The light signal 24 can preferably be provided by means of the energy transmission unit 16, which is arranged, for example, as a charging plate on an accessible surface. Alternatively or in addition, the light signal 24 can be provided by the inductive charging station 14 as a whole. Thus, for example, further elements of the inductive charging station 14, such as for example a component of the inductive charging station 14 mounted on a wall or a column, can provide the light signal 24. This may also involve boundary elements of a parking place for a motor vehicle 10 for charging of the energy accumulator 12.

For an exemplary charging operation of the inductive, i.e., wireless charging, the vehicle should be positioned over the charging plate. However, before the positioning starts, the charging plate should preferably “welcome” the vehicle or the driver with a light signal and thus should confirm that it is ready for the charging operation.

Illumination of the charging plate may be coupled to the setting up of the wireless connection between the vehicle and the charging plate. In other words, as soon as the wireless connection between the vehicle and the charging plate is set up automatically, i.e., without any action by the motor vehicle driver 18, the charging plate can start to light up. Such a function may say “Welcome Home.”

The exemplary embodiment serves merely for explanation of the invention and does not limit the invention. Thus, naturally, functions, in particular the form of the communication channel 22 or the form of the light signal 24, can be configured in any way without departing from the idea underlying the invention. Thus overall it has been shown how an illuminated greeting “Welcome Home” can be implemented by charging stations with induction charging.

### LIST OF REFERENCE SIGNS

10 motor vehicle
12 energy store
14 inductive charging station
16 energy transmission unit
18 motor vehicle driver
20 charging system
22 communication channel
24 light signal

1.-8. (canceled)

9. A method for charging an energy store in a motor vehicle by inductive energy transmission from an energy transmission unit which is anchorable in a stationary manner on an accessible surface and which is part of an inductive charging station to the motor vehicle, comprising the steps of:
constructing a communication channel between the inductive charging station and the motor vehicle for preparing for and/or carrying out charging of the energy store; and
transmitting a light signal by the inductive charging station which is perceivable by a driver of the motor vehicle and which is not transmitted via the communication channel, wherein the light signal signals readiness for charging the energy store of the motor vehicle;
wherein the light signal is transmitted at least partially by the energy transmission unit.

10. The method according to claim 9, wherein the transmitting of the light signal takes place by the energy transmission unit before a final charging position of the motor vehicle is reached.

11. The method according to claim 9, wherein the transmitting of the light signal takes place after the constructing of the communication channel.

12. The method according to claim 9, wherein the communication channel is a wireless connection.

13. The method according to claim 9, wherein the light signal has a time progression which is pulsating and/or is constant at least in some sections.

14. The method according to claim 9, wherein numbers, characters, and/or graphical symbols in any combination are visible and/or highlighted by the light signal.

15. A charging system for a motor vehicle, comprising:
an energy store of the motor vehicle;
an inductive charging station, wherein the energy store is chargeable by the inductive charging station by inductive energy transmission; and
an energy transmission unit which is anchorable in a stationary manner on an accessible supporting surface and which is a part of the inductive charging station;
wherein a communication channel is constructable between the inductive charging station and the motor vehicle for preparing for and/or carrying out charging of the energy store;
wherein a light signal is transmittable by the inductive charging station which is perceivable by a driver of the motor vehicle and which is not transmitted via the communication channel and wherein the light signal signals readiness for charging the energy store of the motor vehicle;
wherein the light signal is transmittable at least partially by the energy transmission unit.
